(19) United States
(12) Patent Application Publication
(10) Pub. No.: US 2012/0240350 A1
(43) Pub. Date: Sep. 27, 2012

(54) BUSHING WITH TRANSFIGURABLE ELECTRICAL CONDUCTION STATE

(75) Inventors: Parag Natu, Neuss (DE); Timothy J. Hagan, Succasunna, NJ (US)

(73) Assignees: SAINT-GOBAIN PERFORMANCE PLASTICS PAMPUS GMBH, Willich (DE); SAINT-GOBAIN PERFORMANCE PLASTICS CORPORATION, Aurora, OH (US)

(21) Appl. No.: 13/427,459

(22) Filed: Mar. 22, 2012

Related U.S. Application Data
(60) Provisional application No. 61/466,206, filed on Mar. 22, 2011.

(51) Int. Cl. H02G 3/02; B21D 53/00

(52) U.S. Cl. 16/2.2; 16/2.1; 29/898.054

(57) ABSTRACT

A bushing has a body with a cylindrical shape, an axis, and a plurality of dimples formed in the body extending in a radial direction with respect to the axis. The body is electrically conductive. A sliding layer that is electrically non-conductive is formed on at least a portion of the body. A coating that is electrically non-conductive is formed on at least a portion of the body. The bushing has an uninstalled configuration where the bushing is electrically non-conductive, and an installed configuration where the bushing is electrically conductive.

### CROSS REFERENCE TO RELATED APPLICATION(S)

The present application claims priority from U.S. Provisional Patent Application No. 61/466,206, filed Mar. 22, 2011, entitled “BUSHING WITH TRANSFIGURABLE ELECTRICAL CONDUCTION STATE,” naming inventors Parag Natu and Timothy J. Hagan, which application is incorporated by reference herein in its entirety.

### FIELD OF THE DISCLOSURE

This disclosure generally relates to bushings and, in particular, to bushings having electrical properties that can be altered.

### BACKGROUND

Sliding bearing composite materials consisting of a load bearing substrate and a sliding layer overlay are generally known. The load bearing substrate and the sliding layer are usually connected by laminating using a suitable adhesive. The sliding bearing composite materials can form a maintenance free bushing used, for example, by the automotive industry. These maintenance free bushings can be used for door, hood, and engine compartment hinges, seats, steering columns, flywheels, balancer shaft bearings, etc. Additionally, maintenance free bushings formed from the sliding bearing composite materials can also be used in non-automotive applications. There is an ongoing need for improved maintenance free bushings that have a longer maintenance free lifetime and improved corrosion resistance.

### SUMMARY

Embodiments of a system, method and apparatus for a bushing may comprise a body having a cylindrical shape, an axis, a plurality of dimples formed in the body extending in a radial direction with respect to the axis, and the body is electrically conductive. A sliding layer is formed on at least a portion of the body that is electrically non-conductive. A coating is formed on at least a portion of the body that is electrically non-conductive. The bushing has an uninstalled configuration wherein the bushing is electrically non-conductive, and an installed configuration wherein the bushing is electrically conductive.

In another embodiment, an assembly comprises an inner member, an outer member, and a bushing located between the inner and outer members. The bushing may be configured as described herein.

In still other embodiments, a method of forming and installing a bushing comprises providing a bushing that is electrically non-conductive, an inner component, and an outer component; joining the bushing to one of the inner and outer components to form a sub-assembly; and joining the other of the inner and outer members to the sub-assembly to form an assembly, such that the bushing becomes electrically conductive, and forming an electrically conductive circuit between the inner component, the bushing and the outer component.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

The present disclosure may be better understood, and its numerous features and advantages made apparent to those skilled in the art by referencing the accompanying drawings.

FIGS. 1 and 2 are isometric and bottom views of an embodiment of a bushing;

FIGS. 3A and 3B are enlarged sectional end views of an embodiment of a layer structure of a bushing, taken along the line 3-3 of FIG. 2, showing uninstalled and installed configurations, respectively;

FIGS. 4 and 5 are schematic sectional views of alternate layer structures for bushings;

FIGS. 6A-6E illustrate various embodiments of bushings;

FIGS. 7-9 illustrate embodiments of hinges having bushings;

FIG. 10 is an embodiment of a bicycle headset having bushings.

The use of the same reference symbols in different drawings indicates similar or identical items.

### DETAILED DESCRIPTION

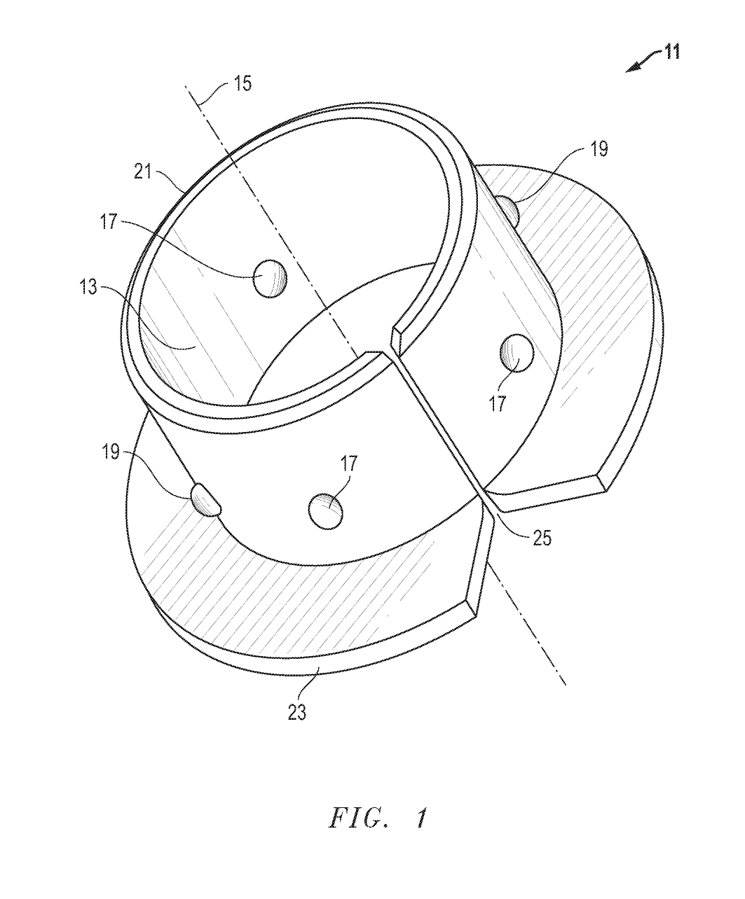

FIGS. 1 and 2 illustrate isometric and bottom views of an embodiment of a bushing 11. Bushing 11 may comprise a body 13 having a cylindrical shape, an axis 15, and a plurality of dimples 17, 19 formed in the body 13 extending in a radial direction with respect to the axis 15. The dimples may have semi-spherical or hemi-spherical shapes in some embodiments. The body 13 is electrically conductive.

A sliding layer 10 may be formed on at least a portion of the body 13. The sliding layer 10 is electrically non-conductive. A coating 14 also may be formed on at least a portion of the body 13. Likewise, the coating 14 is electrically non-conductive. The sliding layer 10 may be formed on an inner surface of the body 13, and the coating may be formed on an outer surface of the body 13. Alternatively, the sliding layer may be on the outer surface and the coating may be on the inner surface.

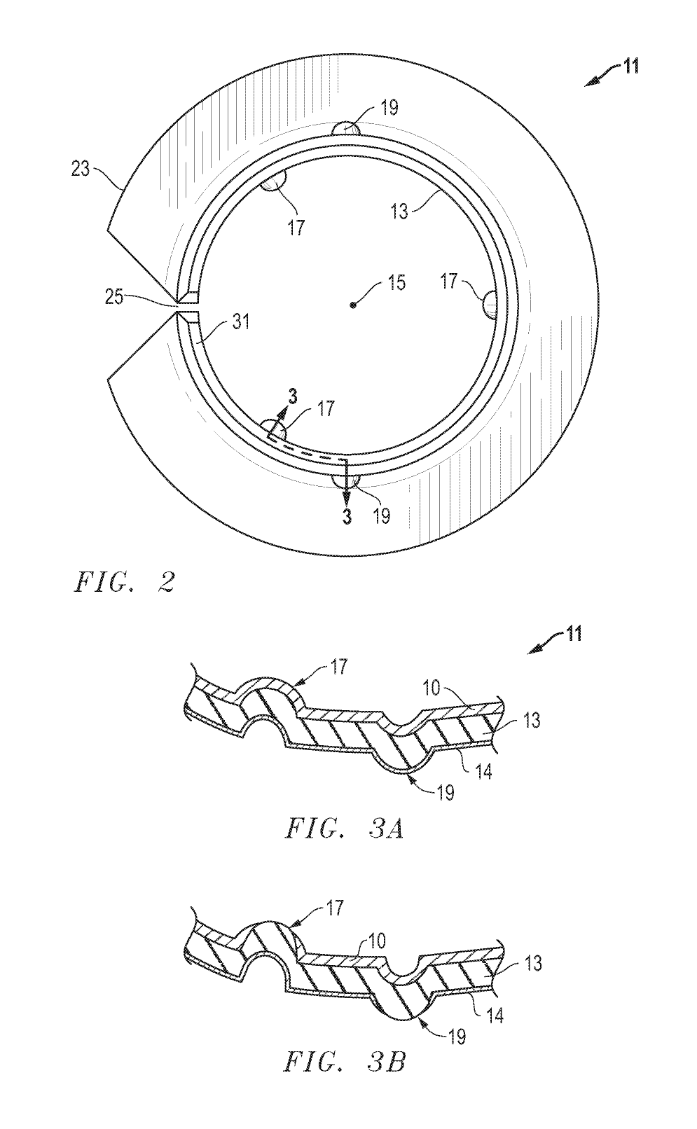

In some embodiments, the body 13 may have a diameter of about 5 to 25 mm, and an axial length of about 5 to 25 mm. In other examples, the body has a radial thickness of about 0.25 to 0.50 mm, the sliding layer 10 may have a thickness of about 0.25 to 0.50 mm, and the coating 14 may have a thickness of less than about 0.08 mm. Sliding layer 10 in FIG. 3 may comprise materials such as those described herein for other embodiments. Coating 14 may comprise an electrically non-conductive material, such as a non-conductive paint. Coating 14 also may comprise materials such as those described herein for other embodiments.

The bushing 11 has an uninstalled configuration (see, e.g., FIGS. 3A) wherein the bushing is electrically non-conductive, and an installed configuration (see, e.g., FIGS. 3B) wherein the bushing is electrically conductive. For example, the uninstalled configuration may have an electrical resistance that is greater than 40 MΩ, and the installed configuration may have an electrical resistance that is less than 1Ω (e.g., about 0 to 0.5Ω).

The installed configuration may comprise dimples 17, 19 that are at least partially void of the sliding layer 10 and coating 14, which enables the bushing 11 to be electrically conductive. For example, as shown in FIG. 3B, some of the sliding layer 10 and coating 14 may be removed or scraped off by the inner and outer components, respectively (see, e.g., FIGS. 7-10), when bushing 11 is installed between them. The geometries for facilitating the removal of these materials may comprise configuring the diameters of the bushing and dimples, and the parameters of the slot 25, with respect to the inner and outer components and the application. For example, the outer diameter of the outer dimples may be slightly greater than the inner diameter of the outer component. Similarly, the inner diameter of the inner dimples may be slightly less than the outer diameter of the inner component.

In some embodiments, the bushing 11 may have a total of at least two or at least three dimples 17, 19. The dimples 17, 19 may be axially aligned with each other. The body 13 has axial ends 21, 23, and the dimples 17, 19 may be closer to one axial end than the other. For example, the one axial end 23 may have a flange extending radially from the body 13 as shown, and the other axial end may be uniform with the cylindrical body 13.

In the illustrated examples, the dimples 17, 19 extend both radially inward and radially outward relative to the body. The installed configuration may comprise both radially inward and outward dimples 17, 19 that are at least partially void of the sliding layer 10 and the coating 14 (see, e.g., FIG. 3B), such that the bushing 11 is electrically conductive through the dimples 17, 19. In some embodiments, no other electrical path is provided. However, in an alternate embodiment, the slot 25 may be provided with one or more protuberances, such as burrs, that may extend radially inward and/or outward from the slot 25 in the body. Like the dimples, the burrs may be provided with the sliding layer and/or coating. To transfigure the bushing from electrically non-conductive to conductive, portions of those materials are removed from the burrs when the bushing is installed. In some embodiments, a combination of both burrs and dimples may be used to complete an electrical circuit.

In some embodiments, three dimples 17 extend radially inward, and two dimples 19 extend radially outward. The radially inward dimples 17 may be symmetrically arrayed about the body with respect to each other (e.g., at pitches of 120°). The radially outward dimples may be symmetrically arrayed about the body with respect to each other (e.g., at pitches of 180°). However, the radially inward dimples 17 may not be symmetrically arrayed with respect to the radially outward dimples 19. See, e.g., FIG. 2.

The body 13 may comprise a split ring having a slit 25 extending along its entire axial length such that the body is circumferentially discontinuous. Each of the radially outward extending dimples 19 may be located at about 90° relative to the slit 25 and axis 15. In other embodiments, dimples 19 are located at about 135° relative to the slit 25. Two of the radially inward extending dimples 17 may be located at about 60° relative to the slit 25 and axis 15, as shown.

In other embodiments, an assembly may comprise an inner member, an outer member, and a bushing located between the inner and outer members. The bushing may comprise the embodiments described elsewhere herein.

In still other embodiments, a method of forming and installing a bushing may comprise providing a bushing that is electrically non-conductive, an inner component, and an outer component; joining the bushing to one of the inner and outer components to form a sub-assembly; and joining the other of the inner and outer members to the sub-assembly to form an assembly, such that the bushing becomes electrically conductive, and an electrically conductive circuit is formed between the inner component, the bushing and the outer component.

The method may comprise forming the electrically conductive circuit by removing at least portions of inner and outer layers from the bushing. The bushing may have dimples, and said at least portions of the inner and outer layers may be removed from the dimples. Forming the electrically conductive circuit may comprise removing at least portions of inner and outer layers from the bushing, such as from the dimples. Portions of both the sliding layer and the coating may be removed to make the bushing electrically conductive. The bushing may initially have an electrical resistance that is greater than 40 MΩ, and after forming the assembly the bushing may have an electrical resistance that is less than 1Ω.

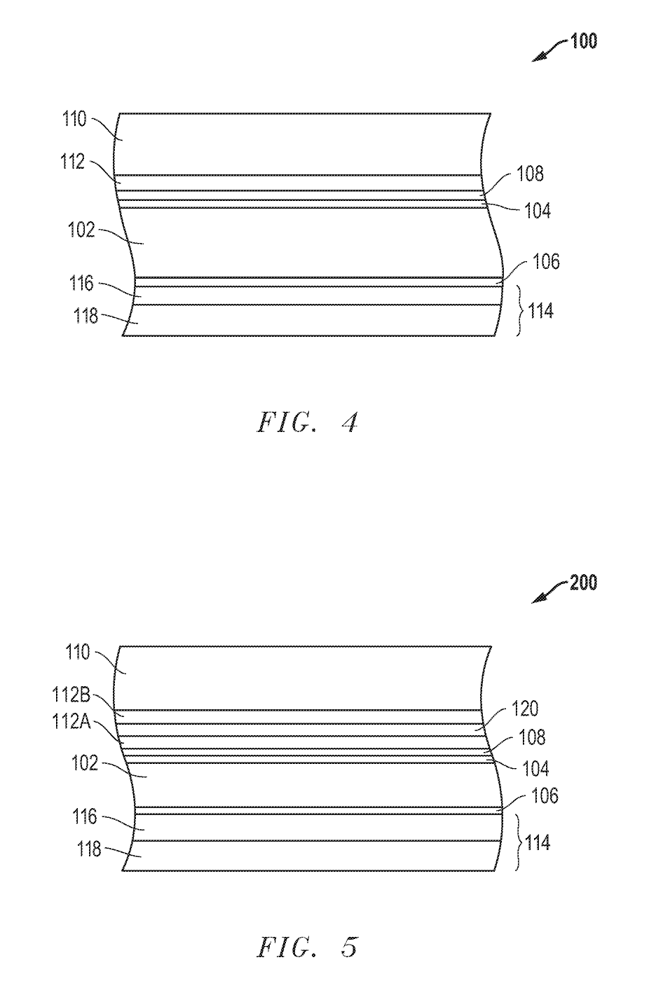

Referring now to FIG. 4, a schematic sectional view illustrating an embodiment of various layers of a bushing 100 is shown. Bushing 100 can include a load bearing substrate 102. The load bearing substrate 102 can be a metallic support layer. The metallic support layer can include a metal or metal alloy such as steel including carbon steel, spring steel, and the like, iron, aluminum, zinc, copper, magnesium, or any combination thereof. In a particular embodiment, the load bearing substrate 102 can be a metal (including metal alloys), such as ferrous alloys. The load bearing substrate 102 may be coated with temporary coatings, such as corrosion protection layers 104 and 106, to prevent corrosion of the load bearing substrate prior to processing.

Additionally, a temporary corrosion protection layer 108 can be applied over top of layer 104. Each of layers 104, 106, and 108 can have a thickness of between about 1 micron to about 50 microns, such as between about 7 microns and about 15 microns. Layers 104 and 106 can include a phosphate of zinc, iron, manganese, or any combination thereof. Additionally, the layers can be a nano-ceramic layer. Further, layers 104 and 106 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic), or coatings of zinc-nickel, zinc-iron, zinc-magnesium, tin, or any combination thereof. Layer 108 can include functional silanes, nano-scaled silane based primers, hydrolysed silanes, organosilane adhesion promoters, solvent/water based silane primers. Temporary corrosion protection layers 104, 106, and 108 can be removed or retained during processing.

A sliding layer 110 can be applied to the load bearing substrate 102. Sliding layer 110 may use an adhesive layer 112. The sliding layer 110 can include a polymer. Examples of polymers that can be used in sliding layer 110 include polytetrafluoroethylene (PTFE), fluorinated ethylene-propylene (FEP), polyvinylidenfluoride (PVDF), polychlorotrifluoroethylene (PCTFE), ethylene chlorotrifluoroethylene (ECTFE), perfluoroalkoxypolymer, polyacetal, polybutylene terephthalate, polyimide, polyetherimide, polyetheretherketone (PEEK), polyethylene, polysulfone, polyamide, polyphenylene oxide, polyphenylene sulfide (PPS), polyurethane, polyester, or any combination thereof. Additionally, sliding layer 110 can include fillers, such as a friction reducing filler. Examples of fillers that can be used in the sliding layer 110 include glass fibers, carbon fibers, silicon, graphite, PEEK, molybdenum disulfide, aromatic polyester, carbon particles, bronze, fluoropolymer, thermoplastic fillers, silicon carbide, aluminum oxide, polyamidimide (PAI), PPS, polyphenylene sulfone (PPSO₂), liquid crystal polymers (LCP), aromatic polyesters (Econol), and mineral particles such as wollastonite and barium sulfate, or any combination thereof. Fillers can be in the form of beads, fibers, powder, mesh, or any combination thereof.

In an embodiment, the sliding layer may include a woven mesh or an expanded metal grid. The woven mesh or expanded metal grid can include a metal or metal alloy such as aluminum, steel, stainless steel, bronze, or the like. Alternatively, the woven mesh can be a woven polymer mesh. In an alternate embodiment, the sliding layer may not include a mesh or grid. In the alternate embodiment of FIG. 5, the woven mesh or expanded metal grid 120 may be embedded between adhesive layers 112A and 112B. Other embodiments may include at least one adhesive layer 112A, 112B.

Returning to FIG. 4, adhesive layer 112 can be a hot melt adhesive. Examples of adhesive that can be used in adhesive layer 112 include fluoropolymers, an epoxy resins, a polyimide resins, a polyether/polyamide copolymers, ethylene vinyl acetates, Ethylene tetrafluoroethylene (ETFE), ETFE copolymer, perfluoroalkoxy (PFA), or any combination thereof. Additionally, the adhesive layer 112 can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive layer 112 can include a copolymer.

Filler particles (functional and/or nonfunctional) may be added in to the adhesive layer such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof.

In an embodiment, the hot melt adhesive can have a melting temperature of not greater than about 250° C., such as not greater than about 220° C. In another embodiment, the adhesive layer 112 may break down above about 200° C., such as above about 220° C. In further embodiments, the melting temperature of the hot melt adhesive can be higher than 250° C., even higher than 300° C.

On an opposing surface of the load bearing substrate 102 from sliding layer 110, a coating, such as a corrosion resistant coating 114, can be applied. The coating 114 can have a thickness of between about 1 micron and about 50 microns, such as between about 5 microns and about 20 microns, such as between about 7 microns and 15 microns. The coating can include an adhesion promoter layer 116 and an epoxy layer 118. The adhesion promoter layer 116 can include a phosphate of zinc, iron, manganese, tin, or any combination thereof. Additionally, the adhesion promoter layer 116 can be nano-ceramic layer. The adhesion promoter layer 116 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic), or coatings of zinc-nickel, zinc-iron, zinc-magnesium, tin, or any combination thereof.

The epoxy layer 118 can be a thermal cured epoxy, a UV cured epoxy, an IR cured epoxy, an electron beam cured epoxy, a radiation cured epoxy, or an air cured epoxy. Further, the epoxy resin can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy resin can include synthetic resin modified epoxies based on phenolic resins, urea resins, melamine resins, benzoguanamine with formaldehyde, or any combination thereof. By way of example, epoxies can include

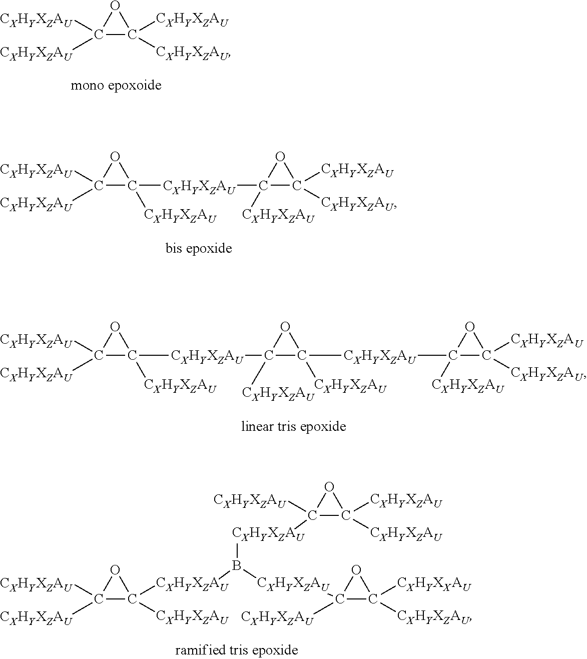

or any combination thereof, wherein C_{X}H_{Y}X_{Z}A_{U} is a linear or ramified saturated or unsaturated carbon chain with optionally halogen atoms X_{Z} substituting hydrogen atoms, and optionally where atoms like nitrogen, phosphorous, boron, etc, are present and B is one of carbon, nitrogen, oxygen, phosphorous, boron, sulfur, etc.

The epoxy resin can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof. Generally, amines can be primary amines, secondary amines, or tertiary amines conforming to the formula R₁R₂R₃N where R can be C_{X}H_{Y}X_{Z}A_{U} as described above.

In an embodiment, the epoxy layer 118 can include fillers to improve the conductivity, such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof. The conductive fillers can allow current to pass through the epoxy coating and can increase the conductivity of the coated bushing as compared to a coated bushing without conductive fillers.

In an embodiment, an epoxy layer can increase the corrosion resistance of the bushing. For example, an epoxy layer, such as epoxy layer 118, can substantially prevent corrosive elements, such as water, salts, and the like, from contacting the load bearing substrate, thereby inhibiting chemical corrosion of the load bearing substrate. Additionally, the epoxy layer can inhibit galvanic corrosion of either the housing or the load bearing substrate by preventing contact between dissimilar metals. For example, placing an aluminum bushing without the epoxy layer within a magnesium housing can cause the magnesium to oxidize. However, an epoxy layer, such as epoxy layer 118, can prevent the aluminum substrate from contacting the magnesium housing and inhibit corrosion due to a galvanic reaction.

Turning to the method of forming the bushing, the sliding layer can be glued to the load bearing substrate using a melt adhesive to form a laminate sheet. The laminate sheet can be cut into strips or blanks that can be formed into the bushing. Cutting the laminate sheet can create cut edges including an exposed portion of the load bearing substrate. The blanks can be formed into the bushing, such as by rolling and flanging the laminate to form a semi-finished bushing of a desired shape.

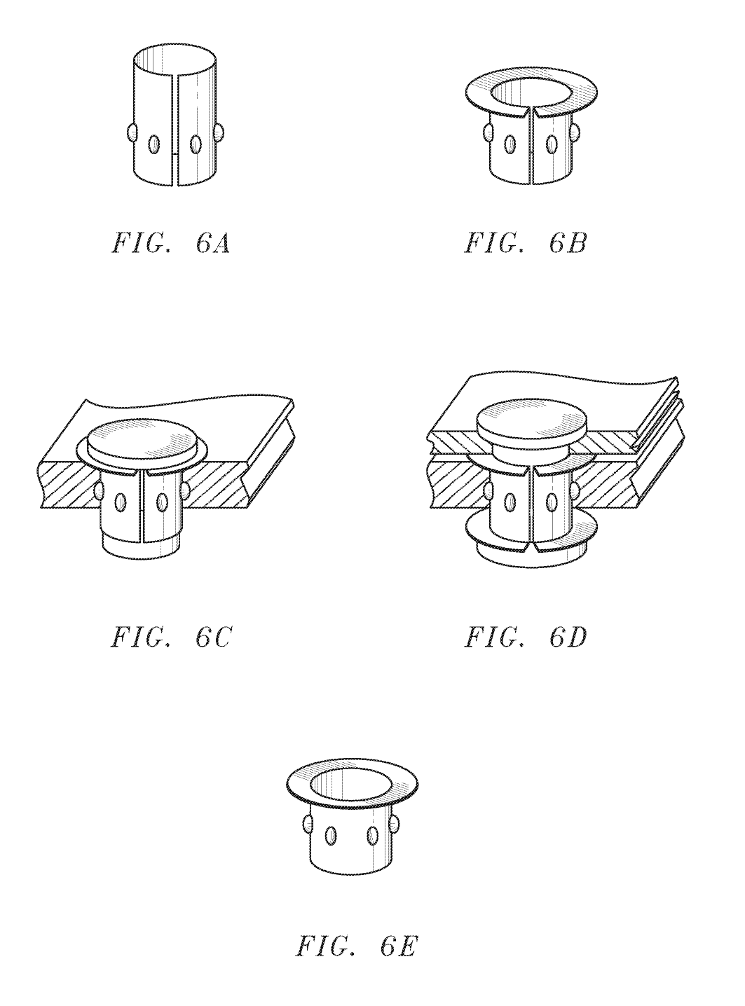

FIGS. 6A through 6E illustrate a number of bushing shapes that can be formed from the blanks. FIG. 6A illustrates a cylindrical bushing that can be formed by rolling. FIG. 6B illustrates a flanged bushing that can be formed by rolling and flanging. FIG. 6C illustrates a flanged bushing mounted in a housing with a shaft pin mounted through the flanged bushing. FIG. 6D illustrates a two-sided flanged bushing mounted in a housing with a shaft pin mounted through the two-sided flanged bushing. FIG. 6E illustrates an L-type bushing that can be formed using a stamping and cold deep drawing process, rather than rolling and flanging.

After shaping the semi-finished bushing, the semi-finished bushing may be cleaned to remove any lubricants and oils used in the forming and shaping process. Additionally, cleaning can prepare the exposed surface of the load bearing substrate for the application of the coating. Cleaning may include chemical cleaning with solvents and/or mechanical cleaning, such as ultrasonic cleaning.

In an embodiment, an adhesion promoter layer, such as adhesion promoter layer 116, can be applied to the exposed surfaces of the load bearing substrate. The adhesion promoter layer can include a phosphate of zinc, iron, manganese, tin, or any combination thereof. The adhesion promoter layer may be applied as a nano-ceramic layer. The adhesion promoter layer 116 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic), or coatings of zinc-nickel, zinc-iron, zinc-magnesium, tin, or any combination thereof. The adhesion promoter layer can be applied by spray coating, e-coating, dip spin coating, electrostatic coating, flow coating, roll coating, knife coating, coil coating, or the like.

Further, application of the corrosion resistant layer can include applying an epoxy coating. The epoxy can be a two-component epoxy or a single component epoxy. Advantageously, a single component epoxy can have a longer working life. The working life can be the amount of time from preparing the epoxy until the epoxy can no longer be applied as a coating. For example, a single component epoxy can have a working life of months compared to a working life of a two-component epoxy of a few hours.

In an embodiment, the epoxy layer can be applied by spray coating, e-coating, dip spin coating, electrostatic coating, flow coating, roll coating, knife coating, coil coating, or the like. Additionally, the epoxy layer can be cured, such as by thermal curing, UV curing, IR curing, electron beam curing, irradiation curing, or any combination thereof. Preferably, the curing can be accomplished without increasing the temperature of the component above the breakdown temperature of any of the sliding layer, the adhesive layer, the woven mesh, or the adhesion promoter layer. Accordingly, the epoxy may be cured below about 250° C., even below about 200° C.

The coating, and particularly the epoxy layer, can be applied to cover the exposed edges of the load bearing substrate as well as the major surface not covered by the sliding layer. E-coating and electrostatic coating can be particularly useful in applying the coating to all exposed metallic surfaces without coating the non-conducting sliding layer. Further, it is preferable for the coating to continuously cover the exposed surfaces of the load bearing substrate without cracks or voids. The continuous, conformal covering of the load bearing substrate can substantially prevent corrosive elements such as salts and water from contacting the load bearing substrate. In an embodiment, the bushing with such a coating can have a significantly increased lifetime.

In an alternate embodiment, the coating can be applied at any point during the processing of the bushing, including before applying the sliding layer, prior to forming the blank but after applying the sliding layer, or between forming the blank and shaping the bushing.

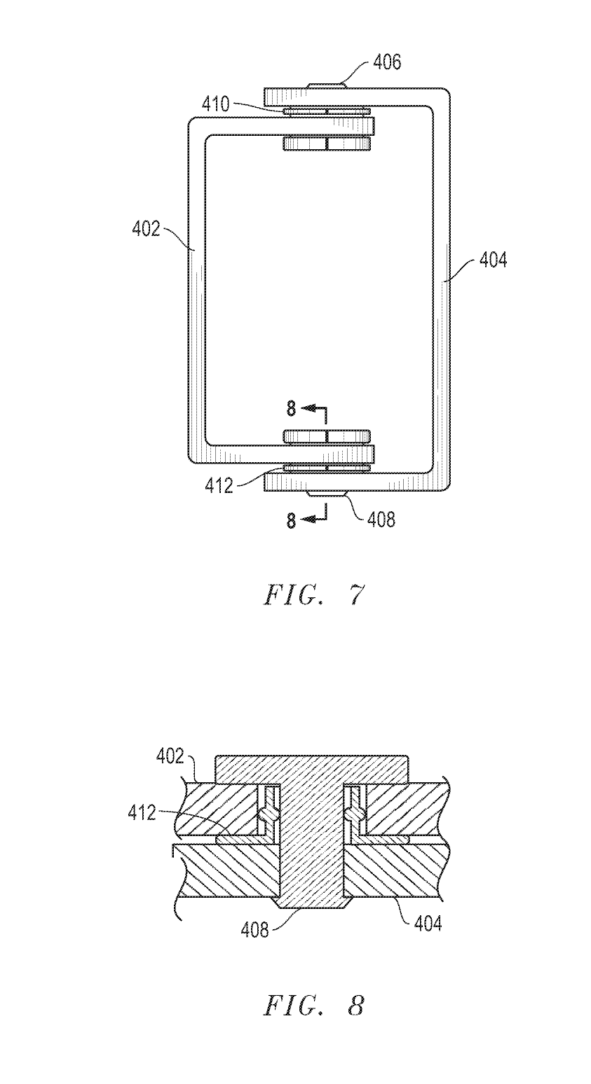

FIGS. 7 and 8 illustrate an embodiment of a hinge 400, such as an automotive door hinge, hood hinge, engine compartment hinge, and the like. Hinge 400 can include an inner hinge portion 402 and an outer hinge portion 404. Hinge portions 402 and 404 can be joined by rivets 406 and 408 and bushings 410 and 412. Bushings 410 and 412 may be constructed as described elsewhere herein. FIG. 8 illustrates a sectional view of hinge 400, showing rivet 408 and bushing 412 in more detail.

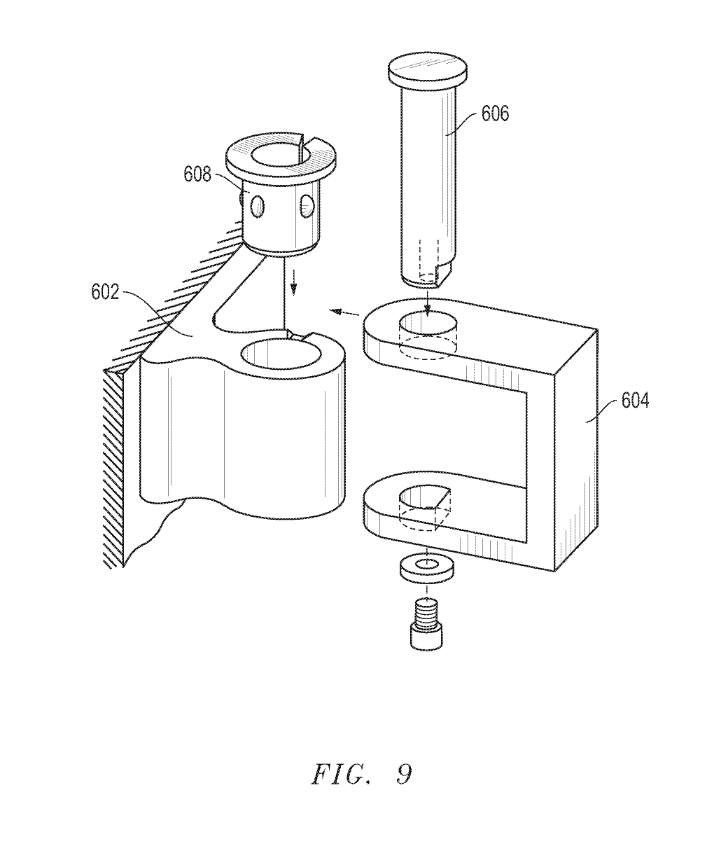

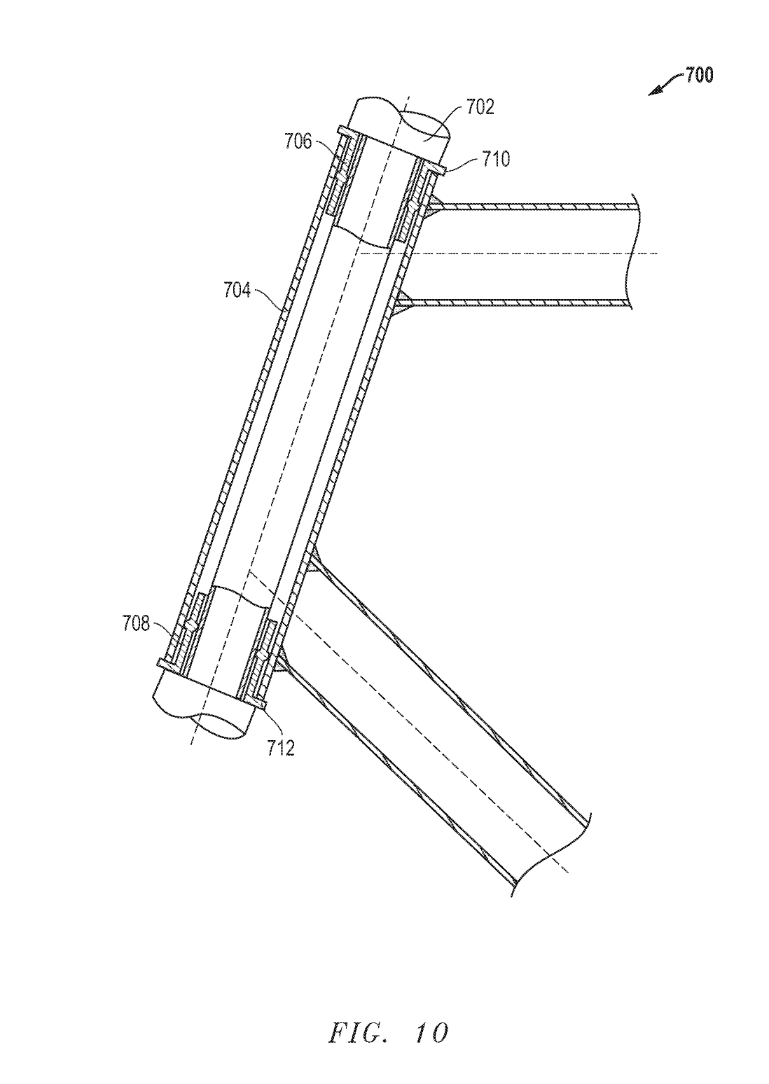

FIG. 9 illustrates another embodiment of a hinge 600, such as an automotive door hinge, hood hinge, engine compartment hinge, and the like. Hinge 600 can include a first hinge portion 602 and a second hinge portion 604 joined by a pin 606 and a bushing 608. Bushing 608 may be constructed as described elsewhere herein.

FIG. 10 illustrates an embodiment of a headset 700 for a two-wheeled vehicle, such as a bicycle. A steering tube 702 can be inserted through a head tube 704. Bushings 706 and 708 can be placed between the steering tube 702 and the head tube 704 to maintain alignment and prevent contact between the steering tube 702 and the head tube 704. Bushings 706, 708 may be constructed as described elsewhere herein. Additionally, seals 710 and 712 can prevent contamination of the sliding surface of the bushing by dirt and other particulate matter.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. The order in which activities are listed is not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A bushing, comprising:
a body having a cylindrical shape, an axis, a plurality of dimples formed in the body extending in a radial direction with respect to the axis, and the body is electrically conductive;
a sliding layer on at least a portion of the body that is electrically non-conductive;
a coating on at least a portion of the body that is electrically non-conductive; and
the bushing has an uninstalled configuration wherein the bushing is electrically non-conductive, and an installed configuration wherein the bushing is electrically conductive.

2. A bushing according to claim 1, wherein the uninstalled configuration has an electrical resistance that is greater than 40 MΩ, and the installed configuration has an electrical resistance that is less than 1Ω.

3. A bushing according to claim 1, wherein the installed configuration comprises dimples that are at least partially void of the sliding layer.

4. A bushing according to claim 1, wherein there are at least two dimples.

5. A bushing according to claim 1, wherein there are at least three dimples.

6. A bushing according to claim 1, wherein the dimples are axially aligned with each other.

7. A bushing according to claim 1, wherein the body has axial ends, and the dimples are closer to one axial end than the other.

8. A bushing according to claim 7, wherein said one axial end has a flange extending radially from the body, and the other axial end is uniform with the cylindrical body.

9. A bushing according to claim 1, wherein the dimples extend both radially inward and radially outward relative to the body.

10. A bushing according to claim 9, wherein the installed configuration comprises both radially inward and outward dimples that are at least partially void of the sliding layer and the coating, such that the bushing is electrically conductive through the dimples.

11. A bushing according to claim 9, wherein there are three dimples that extend radially inward, and two dimples that extend radially outward.

12. A bushing according to claim 9, wherein the radially inward dimples are symmetrically arrayed about the body with respect to each other, the radially outward dimples are symmetrically arrayed about the body with respect to each other, but the radially inward dimples are not symmetrically arrayed with respect to the radially outward dimples.

13. A bushing according to claim 12, wherein the body is a split ring having a slit extending along its entire axial length such that the body is circumferentially discontinuous, each of the radially outward extending dimples are located at about 90° relative to the slit and axis, and two of the radially inward extending dimples are located at about 60° relative to the slit and axis.

14. A bushing according to claim 1, wherein the dimples are semi-spherical.

15. A bushing according to claim 1, wherein the sliding layer is on an inner surface of the body, and the coating is on an outer surface of the body.

16. A bushing according to claim 1, wherein the sliding layer is on an outer surface of the body, and the coating is on an inner surface of the body.

17. A bushing according to claim 1, wherein the body has a radial thickness of about 0.25 to 0.50 mm, the sliding layer has a thickness of about 0.25 to 0.50 mm, and the coating has a thickness of less than about 0.08 mm.

18. An assembly, comprising:
an inner member;
an outer member; and
a bushing located between the inner and outer members, the bushing comprising:
a body having a cylindrical shape, an axis, a plurality of dimples formed in the body extending in a radial direction with respect to the axis, and the body is electrically conductive;
a sliding layer on at least a portion of the body that is electrically non-conductive;
a coating on at least a portion of the body that is electrically non-conductive; and
the bushing has an uninstalled configuration wherein the bushing is electrically non-conductive and not installed between the inner and outer members, and an installed configuration wherein the bushing is electrically conductive and installed between the inner and outer members.

19-34. (canceled)

35. A method of forming and installing a bushing, comprising:
providing a bushing that is electrically non-conductive, an inner component, and an outer component;
joining the bushing to one of the inner and outer components to form a sub-assembly; and
joining the other of the inner and outer members to the sub-assembly to form an assembly, such that the bushing becomes electrically conductive, and forming an electrically conductive circuit between the inner component, the bushing and the outer component.

36. A method according to claim 35, wherein forming the electrically conductive circuit comprises removing at least portions of inner and outer layers from the bushing.

37. A method according to claim 36, wherein the bushing has dimples, and said at least portions of the inner and outer layers are removed from the dimples.

38. A method according to claim 35, wherein the bushing has a sliding layer on at least a portion of the body that is electrically non-conductive, a coating on at least a portion of the body that is electrically non-conductive, and portions of both the sliding layer and the coating are removed to make the bushing is electrically conductive.

39. A method according to claim 35, wherein the bushing initially has an electrical resistance that is greater than 40 MΩ, and after forming the assembly the bushing has an electrical resistance that is less than 1Ω.
